(19) United States
(12) Patent Application Publication
(10) Pub. No.: US 2025/0178506 A1
(43) Pub. Date: Jun. 5, 2025

(54) MASSAGE BLADDER ASSEMBLY

(71) Applicant: Lear Corporation, Southfield, MI (US)

(72) Inventors: David ABDELLA, Royal Oak, MI (US); Samuel BLAIR, Troy, MI (US); Matthew MORRIS, Rochester Hills, MI (US)

(21) Appl. No.: 18/524,414

(22) Filed: Nov. 30, 2023

(51) Int. Cl. B60N 2/90; B60N 2/56

(52) U.S. Cl. CPC B60N 2/976; B60N 2/5657

(57) ABSTRACT

Massage assemblies such as for a vehicular seat are disclosed. The massage assemblies include a plurality of bladder disposed along the outer periphery such that one or more of the bladders may be folded inward to their operational position. Each bladder may be connected to one or more fluid passages having projections such that air flow is maintained within the fluid passage after folding.

### TECHNICAL FIELD

Massage assemblies are disclosed. More specifically, the massage assemblies for vehicular seats include a plurality of bladders disposed along the outer periphery, which are folded inward before use.

### BRIEF DESCRIPTION OF THE DRAWINGS

FIG. 1 is a perspective view of an embodiment of a seat such as for a vehicle.

FIG. 2 is a front view of a portion of a first embodiment of a bladder assembly blank having bladders defined along the outer periphery of the assembly.

FIG. 3 is a front view of the same portion of the first embodiment with folds such that certain bladders are more proximate the ventilation aperture.

FIG. 4 is a front view of a third embodiment of a bladder assembly having folds such that bladders disposed along the outer periphery when unfolded are more proximate the center.

FIG. 5 is a back view of the third embodiment showing the bladders are folded forward such that they would be arranged more proximate a trim cover configured to contact an occupant.

FIG. 6 is a front view of a second embodiment of a bladder assembly having bladders defined in their operational position adjacent a central ventilation aperture.

FIG. 7 is a back view of the second embodiment.

FIG. 8 is a cross-sectional view of an embodiment of the fluid passage.

FIG. 9 is a flow chart illustrating a method of making a bladder assembly.

### DETAILED DESCRIPTION

As required, detailed embodiments of the present invention are disclosed herein. However, it is to be understood that the disclosed embodiments are merely examples of the invention that may be embodied in various and alternative forms. The figures are not necessarily to scale. Some features may be exaggerated or minimized to show details of particular components. Specific structural and functional details disclosed herein are not to be interpreted as limiting, but merely as a representative basis for teaching one skilled in the art to variously employ the present invention.

As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Moreover, except where otherwise expressly indicated, all numerical quantities in this disclosure are to be understood as modified by the word “about” in describing the broader scope of this disclosure. Practice within the numerical limits stated is generally preferred. Also, unless expressly stated to the contrary: percent, “parts of,” and ratio values are by weight. The term “polymer” includes “oligomer,” “copolymer,” “terpolymer,” and the like. The description of a group or class of materials as suitable or preferred for given purpose implies the mixtures of any two or more of the members of the group or class are equally suitable or preferred. Molecular weights provided for any polymers refers to number average molecular weight. A description of constituents in chemical terms refers to the constituents at the time of addition to any combination specified in the description and does not necessarily preclude chemical interactions among the constituents of a mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

This disclosure is not limited to the specific embodiments and methods described below, as specific components and/or conditions may vary. Furthermore, the terminology used herein is used only for the purpose of describing particular embodiments and is not intended to be limiting in any way.

The term “substantially” or “generally” may be used herein to describe disclosed or claimed embodiments. The term “substantially” or “generally” may modify a value or relative characteristic disclosed or claimed in the present disclosure. In such instances, “substantially” or “generally” may signify that the value or relative characteristic it modifies is within manufacturing tolerances or within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

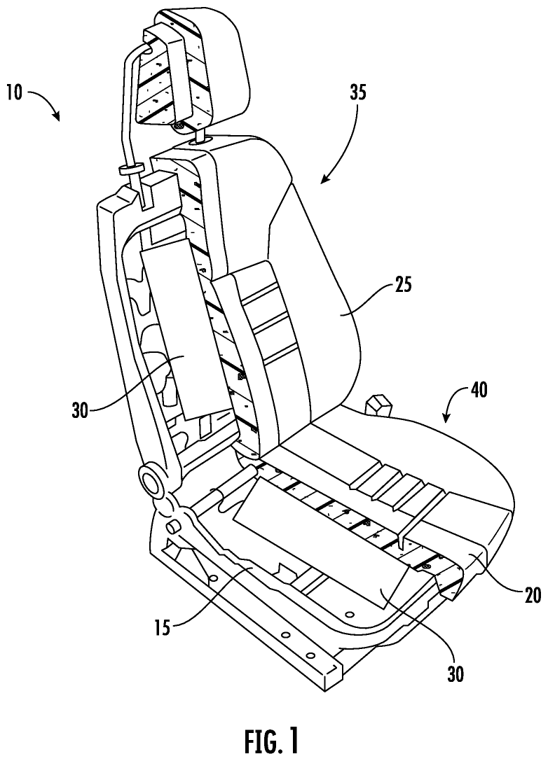

Referring to FIG. 1, a seat 10 such as for a vehicle (e.g., a motorcycle, automobile, aircraft, watercraft, locomotive, etc.) is disclosed. In various embodiments, the seat 10 includes a frame 15 such as for supporting an occupant and various other components of the seat 10. In one or more embodiments, the seat 10 also includes a cushion 20 supported by the frame 15, and a trim cover 25 having a surface for contacting an occupant and being disposed over the cushion 20. In at least some of the embodiments, the cushion 20 is a foam and/or formed of a plurality of polymeric filaments. The seat 10 also includes a fluid bladder assembly 30 arranged such as to provide a massage effect. In one or more embodiments, the seat 10 includes a seat back 35 and a seat bottom 40. In variations, the assembly 30 is disposed in the seat back 35 and/or the seat bottom 40.

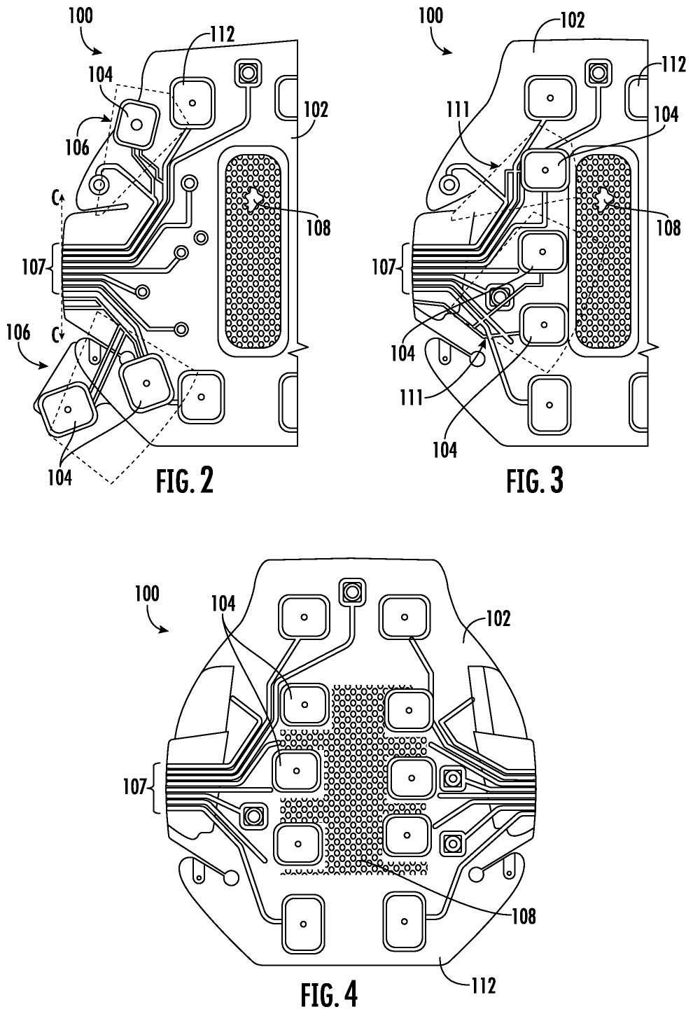

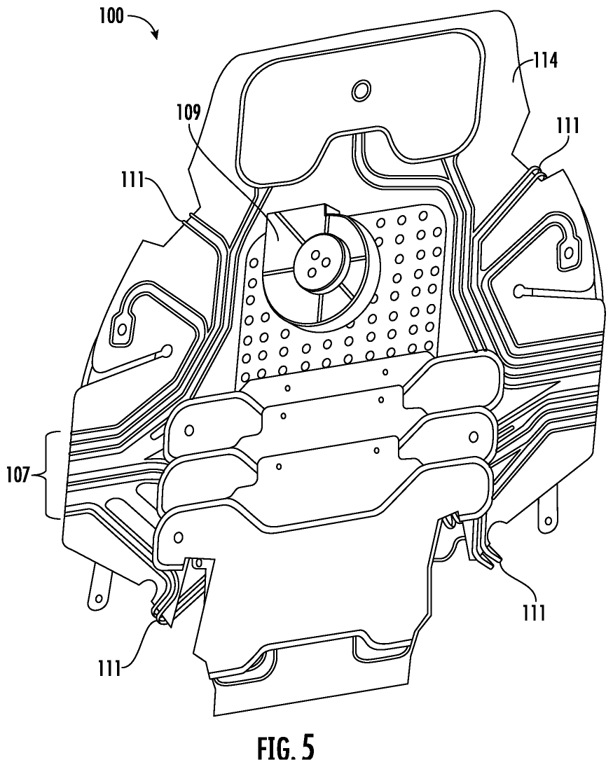

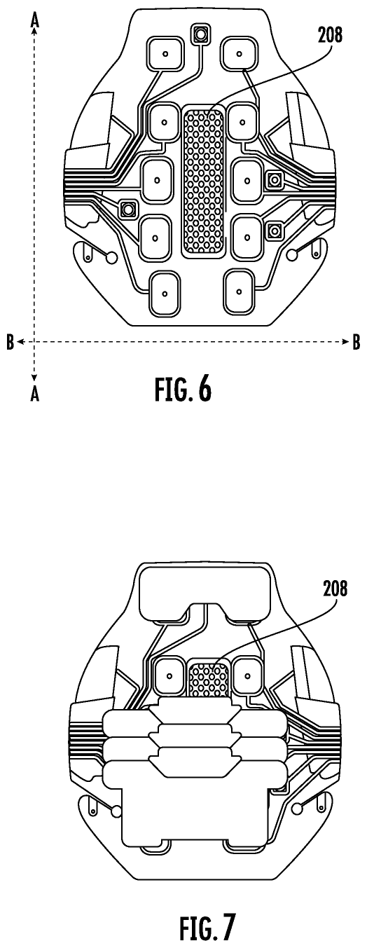

Referring to FIGS. 2-4, a fluid bladder assembly 100 including a substrate 102 and one or more fluid bladders 104 (e.g., a plurality of fluid bladders) disposed along the outer periphery 106 of the substrate 102. In numerous embodiments, the one or more fluid bladders 104 are in fluid communication with a fluid actuator 109 (e.g., pump, air compressor, blower) via one or more of fluid passages 107 (e.g., a plurality of fluid passages). In a refinement, the one or more fluid passages 107 are disposed between a central portion and the one or more fluid bladders 104. In various embodiments, the substrate 102 defines a ventilation aperture 108 (e.g., inlet/outlet). In a variation, the ventilation aperture 108 is centrally located in the substrate 102. In one or more embodiments, the ventilation aperture 108 provides fluid communication between a fluid actuator 109 such as a blower and a seated occupant. In other words, a plurality of fluid actuators may used. For example, in a variation, a pump cooperates with the one or more fluid bladders 104 and a blower cooperates with the ventilation aperture 108.

In one or more embodiments, the seat assembly 10 or a subassembly thereof, includes a controller for operation of the fluid actuator 109 such as a pump that is in fluid communication with the bladder assembly 100 to fill (e.g., inflate) the one or more bladders 104 of the assembly 100 and impart a pressure upon a seated occupant. For example, controller activates operation of the fluid actuator 109 (e.g., pump) such that the fluid (e.g., air) passes from the fluid actuator 109 through the one or more fluid passages 107 to the one or more fluid bladders 104. In a refinement, a valve assembly (not shown) cooperates with the fluid passages 107 and/or fluid bladders 104 to facilitate inflation and deflation of the fluid bladders 104 and to impart a massaging effect. For example, the controller operates the valve assembly and/or fluid actuator 109 to inflate and deflate one or more fluid bladders 104 from a plurality of fluid bladders such as in a sequence or a pattern to provide (variable) pressure such as at different locations of the trim cover such that an occupant receives a massage effect. In a refinement, the controller also operates a fluid actuator 109 such as a blower individually or simultaneously to displace a fluid such as air through the ventilation aperture 108 to provide the seated occupant ventilation. In a variation, the ventilation aperture 108 cooperates with a trim cover 25 configured to provide ventilation such as through a plurality of perforations in the trim cover 25.

In numerous embodiments, the size (e.g., cross-sectional surface area/surface area normal to the fluid flow or in the plane defined by A-A and B-B) of the ventilation aperture 108 corresponds to the amount and/or degree of ventilation such that a larger ventilation aperture 108 corresponds to better ventilation of the occupant. By disposing the one or more fluid bladders 104 along the outer periphery 106 and folding them inward towards a central portion or the central ventilation aperture 108, a larger ventilation aperture 108 is provided. In other words, when assembled for use such as in a vehicle seat, the bladder assembly 100 includes one or more folds 111 (e.g., a plurality of folds) corresponding to the one or more fluid bladders 104 that were originally disposed along the outer periphery 106 and folded inward towards the central ventilation aperture 108. For example, the ventilation aperture 108 is at least 36 square inches, or more preferably at least 91 square inches, or even more preferably at least 150 square inches, whereas conventional ventilation apertures 208 may be much smaller (e.g., no more than 100 square inches). In some embodiments, the ventilation aperture 108 is at least 50% of a cross-sectional area of the plurality of bladders (such as along the plane defined by A-A and B-B), or more preferably at least 70%, or even more preferably at least 90%.

In a refinement, a spacer 110 is disposed in the ventilation aperture 108 to maintain fluid communication under the pressure or weight of the occupant. In other words, the spacer 110 avoids collapse of the inlet and/or outlet such as from other adjacent layers (e.g., the cushion) or the substrate 102 itself. In various embodiments, the spacer 110 is any suitable spacer material (e.g., a spacer fabric). In other embodiments, the spacer is a non-fabric spacer. In a refinement, the spacer material is a rigid non-malleable plastic defining a plurality of open cells (e.g., cellular) having, for example, a thickness of at least 8 mm, or more preferably at least 10 mm, or even more preferably at least 12 mm. For example, the spacer 110 has a thickness (e.g., along the direction flow) of 1 to 20 mm, or more preferably 5 to 18 mm, or even more preferably 7 to 15 mm.

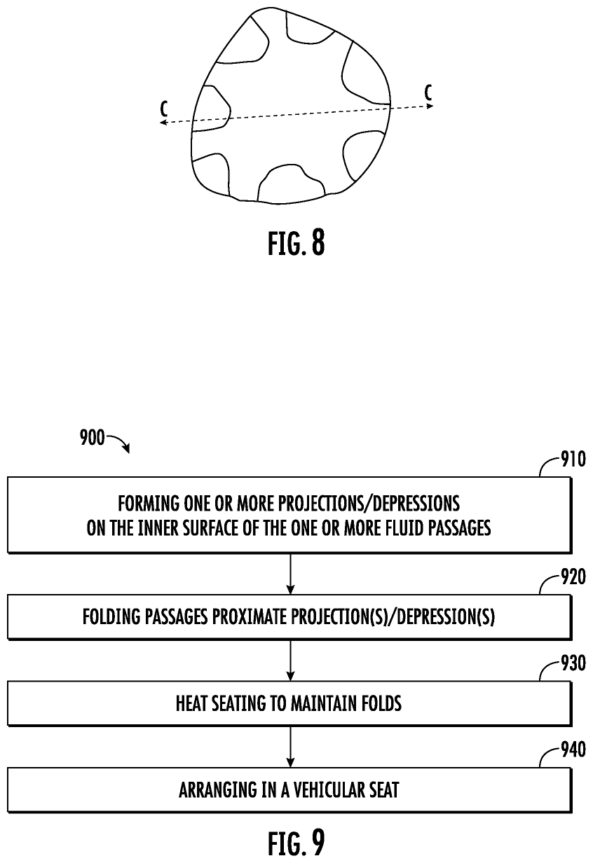

In one or more embodiments, the substrate 102 includes at least a first sheet 112 and a second sheet 114. In various embodiments, the first and second sheets 112, 114 cooperate, such as by being fixed together (e.g., sewn, heat staked, glued, welded, ultrasonically welded, etc.), to define the one or more fluid passages 107. In variations, the one or more fluid passages include one or more projections/depressions (e.g., dimples) such as a plurality of projections/depressions arranged on the inner surface of the fluid passage 107 at the folds 111 to maintain fluid communication and/or avoid collapse, as shown in FIG. 8, which is a cross-sectional view of a passage along C-C of FIG. 2. In a refinement, the sheets 112, 114 are a flexible plastic/polymeric material such as a polyolefin (e.g., polyethylene) or polyurethane and each having a thickness of no more than 1.5 mm, or more preferably no more than 1 mm, or even more preferably no more than 0.8 mm. For example, each sheet may be 0.05 to 2 mm, or more preferably 0.1 to 1 mm, or even more preferably 0.25 to 0.75 mm. In various embodiments, one or more sheets may cooperate with the first and/or second sheets 112, 114 to define the one or more bladders 104.

In various embodiments, the plurality of fluid bladders 104 are arranged more proximate the trim cover 25 of the seat assembly 10 once the substrate 102 is folded. In a variation, the substrate 102 and/or fluid bladders 104 are fixed such as by heat staking the substrate 102 back to itself and/or heating stacking the fluid bladders 104 to the substrate 102 to hold the bladders 104 in place after folding or make the folds 111 permanent.

In various embodiments, the frame 15 is made of any suitable material for supporting various subassemblies and a seated occupant. In a refinement, the frame 15 is made of a rigid material such as metal (e.g., steel and/or aluminum), plastic, and/or wood.

Referring to FIG. 9, a method 900 of preparing a fluid bladder assembly, such as for massaging an occupant in vehicular seat, is disclosed. In one or more embodiments, the method 900 includes (1) forming one or more (e.g., a plurality of) projections and/or depressions (e.g., dimples, recesses, and/or dents) on the inner surface of one or more (e.g., a plurality) of fluid (e.g., pneumatic) passages such as to maintain fluid communication and/or avoid collapse of the one or more fluid air passages when folded (i.e., step 910) and (2) folding the one or more passages proximate the projections and/or depressions (i.e., step 920). In a refinement, the one or more projections and/or depressions are arranged on the inner surface where one or more folds will be made. In a variation, the fluid passages are configured to be in cooperation or are in cooperation with one or more (e.g., a plurality of) corresponding fluid (e.g., pneumatic) bladders that are arrange along the outer periphery of a bladder assembly blank or substrate thereof. In numerous embodiments, the passages are folded inward towards a central portion or ventilation aperture defined by the substrate. In a refinement, the passages are folded such that the one or more bladders are disposed in front of the substrate (i.e., configured to be more proximate a seat occupant). In various embodiments, the method 900 also includes fixing the substrate/one or more bladders/one or more passages to the substrate to maintain the folds (i.e., step 930). In some embodiments, the method 900 further includes assembling the bladder assembly in a seat such as in a vehicle (i.e., step 940) such that the fluid bladders are more proximate a seated occupant.

In one or more embodiments, a controller includes one or more controllers or control modules for the various components and systems. The controller and control system may include any number of controllers, or may be integrated into a single controller, or have various modules. Some or all of the controllers may be connected by a controller area network (CAN) or other system. It is recognized that any controller, circuit, or other electrical device disclosed herein may include any number of processors, microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electrical devices as disclosed herein may be configured to execute a computer-program that is embodied in a non-transitory computer readable medium that is programmed to perform any number of the functions as disclosed herein.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

According to a first clause, an assembly comprising a substrate, a plurality of fluid bladders, and a plurality of fluid passages in fluid communication with the plurality of fluid bladders. The plurality of fluid passages is defined in the substrate. The substrate further defines a ventilation aperture in a central portion of the substrate. The plurality of bladders is disposed along the substrate and folded inward towards the ventilation aperture. Each fluid passage defines an inner surface comprising a plurality of projections and the projections are arranged such that the fluid passage is maintained where the plurality of bladders is folded towards the central ventilation aperture.

According to a second clause, the plurality of bladders of any of the prior or following clauses is folded towards the ventilation aperture by a plurality of folds.

According to a third clause, the plurality of bladders of any of the prior or following clauses is disposed along an outer periphery of the substrate when unfolded.

According to a fourth clause, the substrate of any of the prior or following clauses is comprised of a first sheet cooperating with a second sheet to form the plurality of bladders.

According to a fifth clause, the first and second sheets of any of the prior or following clauses cooperate to form the plurality of fluid passages.

According to a sixth clause, the sheets of any of the prior or following clauses are polyolefin or polyurethane sheets.

According to a seventh clause, the sheets of any of the prior or following clauses each have a thickness of 0.05 to 2 mm.

According to an eighth clause, the ventilation aperture of any of the prior or following clauses is a least fifty percent of a cross-section area of the plurality of bladders.

According to a ninth clause, the ventilation aperture of any of the prior or following clauses is a least seventy percent of a cross-section area of the plurality of bladders.

According to a tenth clause, the ventilation aperture of any of the prior or following clauses is a least ninety percent of a cross-section area of the plurality of bladders.

According to an eleventh clause, a plastic spacer is disposed in the ventilation aperture of any of the prior or following clauses.

According to a twelfth clause, a non-fabric spacer is disposed in the ventilation aperture of any of the prior or following clauses.

According to a thirteenth clause, the spacer of any of the prior or following clauses has a thickness of 1 to 20 mm.

According to a fourteenth clause, the plurality of bladders of any of the prior or following clauses is arranged more proximate a trim cover of a seat assembly when the substrate is folded.

According to a fifteenth clause, the plurality of bladders of any of the prior or following clauses is heat staked to the substrate after folding.

According to a sixteenth clause, a seat comprises a frame that supports the assembly of any of the prior or following clauses.

According to a seventeenth clause, a bladder assembly blank comprises a substrate defining a plurality of fluid passages and a plurality of fluid bladders disposed along an outer periphery of the substrate. The plurality of fluid passages is in fluid communication with the plurality of fluid bladders. The plurality of fluid passages also comprises a plurality of dimples arranged such that the plurality of fluid passages is maintained when the plurality of fluid bladders is folded towards a central portion of the substrate.

According to an eighteenth clause, the central portion of the substrate of any of the prior or following clauses defines a ventilation aperture.

According to a nineteenth clause, the plurality of fluid passages of any of the prior or following clauses is disposed between the central portion and the plurality of fluid bladders.

According to a twentieth clause, a method of preparing a bladder assembly comprises forming a plurality of projections arranged on an inner surface of a plurality of passage that are in fluid cooperation with a plurality of bladders along a substrate and folding the plurality of bladders towards a ventilation aperture in the substrate.

What is claimed is:

1. An assembly comprising:
a substrate defining a ventilation aperture and a plurality of fluid passages; and
a plurality of bladders disposed along the substrate and folded towards the ventilation aperture,
each of the bladders of the plurality of bladders in fluid communication with a corresponding fluid passage of the plurality of fluid passages,
each fluid passage defining an inner surface comprising a plurality of projections,
the plurality of projections arranged such that the fluid passage is maintained where the plurality of bladders is folded towards the ventilation aperture.

2. The assembly of claim 1, wherein the plurality of bladders is folded towards the ventilation aperture by a plurality of folds.

3. The assembly of claim 1, wherein the plurality of bladders is disposed along an outer periphery of the substrate when unfolded.

4. The assembly of claim 1, wherein the substrate is comprised of a first sheet cooperating with a second sheet to form the plurality of bladders.

5. The assembly of claim 4, wherein the first and second sheets cooperate to form the plurality of fluid passages.

6. The assembly of claim 4, wherein the sheets are polyolefin or polyurethane sheets.

7. The assembly of claim 6, wherein each sheet has a thickness of 0.05 to 2 mm.

8. The assembly of claim 1, wherein the ventilation aperture is at least fifty percent of a cross-sectional area of the plurality of bladders.

9. The assembly of claim 1, wherein the ventilation aperture is at least 70% of a cross-sectional area of the plurality of bladders.

10. The assembly of claim 1, wherein the ventilation aperture is at least 90% of a cross-sectional area of the plurality of bladders.

11. The assembly of claim 1, wherein a plastic spacer is disposed in the ventilation aperture.

12. The assembly of claim 1, wherein a non-fabric spacer is disposed in the ventilation aperture.

13. The assembly of claim 12, wherein the spacer has a thickness of 1-20 mm.

14. The assembly of claim 1, wherein the plurality of bladders are arranged more proximate a trim cover of a seat assembly when the substrate is folded.

15. The assembly of claim 1, wherein the plurality of bladders is heat staked to the substrate after folding.

16. A seat comprising a frame supporting the assembly of claim 1.

17. A bladder assembly blank comprising:
a substrate defining a plurality of fluid passages in fluid communication with a plurality of fluid bladders,
the plurality of fluid bladders disposed along an outer periphery of the substrate,
the plurality of fluid passages comprising a plurality of dimples arranged such that the plurality of fluid passages is maintained when the plurality of fluid bladders is folded towards a central portion of the substrate.

18. The bladder assembly blank of claim 17, wherein the central portion defines a ventilation aperture.

19. The bladder assembly blank of claim 18, wherein the plurality of fluid passages are disposed between the central portion and the plurality of fluid bladders.

20. A method of preparing a bladder assembly comprising:
forming a plurality of projections arranged on an inner surface of a plurality of passages that are in fluid cooperation with a plurality of bladders along a substrate; and
folding the plurality of bladders toward a ventilation aperture in the substrate.
